(19) United States
(12) Patent Application Publication
(10) Pub. No.: US 2003/0164076 A1
(43) Pub. Date: Sep. 4, 2003

(54) Method and device for shortening the flap of paper following a roll change

(76) Inventor: Ernst Klas, Siegburg (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/362,804

(22) PCT Filed: Jul. 24, 2001
(86) PCT No.: PCT/EP01/08530

(51) Int. Cl. B26D 1/00

(52) U.S. Cl. 83/13; 83/100

(57) ABSTRACT

During an unsupported roll change, a flap of paper resulting at the joining point can lead to disruptions in a processing station situated down-stream. According to the invention, the paper web (1) is advanced on a carrying element that is moved faster than the paper web (1), for example, on a suction roll (5). Said carrying element is arranged so close to the continuous paper web (1) that it catches the flap (8) of paper, which is located on the paper web (1), with frictional engagement. The flap (8) of paper is advanced with its rear side on the paper web (1) in a sliding manner and in relation to said paper web (1) in order to cause the leading part of the flap (8) of paper to arch in a wavelike manner. The arched flap (8) of paper strikes a blade (6) and is cut away until it can no longer cause any disruptions.

The invention relates to a method according to the introductory clause of claim and to an apparatus intended for carrying out this method according to the introductory clause of claim 6.

Continuously operating paper-treating machines, in particular rotating-roll machines, are loaded with paper strips that are wound off supply rolls. When one roll is depleted, it is replaced by a new roll without stopping the treatment machine. Roll changers are known that effect a so-called “on-the-fly roll change.” This is done by providing an adhesive band on the leading end of a fresh roll waiting for use. The new roll is rotated and brought to a peripheral speed that is synchronized with that of the almost empty roll. At the appropriate time the paper strip is pressed against the new roll so as to contact the adhesive band. In this manner the leading end of the new strip is adhered to the running-out strip. The running-out strip is cut off after a slight delay. The delay is necessitated by the inertia of the cutter and the cycling time of the control system. This leaves a so-called flap that projects from the adhesive band and that has a length determined by the length of the delay. The length of the flap is a function of the strip speed as well as of the delay time. If for example the delay is 10 ms and the strip speed is 15 m/s, the flap is 150 mm long.

Practice has shown that such flaps can cause problems in the downstream treatment stations. German patent document 198 04 415, which the instant invention is based on, describes a method that manages to cut the flap to a harmless residue of at most several millimeters long. It also describes several systems for carrying out the method. With this known method the glued-together paper strips are deflected about an arc having a center of curvature on the face opposite the flap. When the flap moves through the arc it is swung out by centrifugal force and cut by a blade that is closely spaced with the strip. The separating effect of the centrifugal force can be augmented by an air blast that is directed between the paper strip and the flap parallel to the travel direction of the strip. In order to ensure that the cut is made, in one embodiment a separating device, e.g. a suction drum or belt, is set at a spacing of 20 to 60 mm from the paper strip upstream of the blade and is driven at a speed that is greater than the travel speed of the strip. The flap that is separated by the air blast and centrifugal force from the strip is held by the suction of the separating device, accelerated by friction, and thus fed to the blade.

It is an object of the invention to simplify the method described in the introductory clause of claim 1 and also to provide a simplified apparatus according to the introductory clause of claim 2 for carrying out the new method.

The first part of the stated object is attained by the characterizing feature of claim 1. Unlike the prior art, with the new method the flap is not first separated from the strip before it is frictionally engaged by the separating device. The separating device engages the flap while it is lying against the strip and accelerates it to a speed greater than the travel speed of the strip. This bows out the flap right up to the location where it is glued to the strip and in this manner separates it from the strip. The flap moves to the blade in this position and is cut immediately adjacent the glued location.

The second part of the stated object is attained by the feature of claim 2.

The features of claims 3 through 10 relate to various embodiments of the apparatus for carrying out the method.

The drawing serves for explaining the invention. FIGS. 1 through 7 schematically show respective embodiments of the invention.

As shown in FIG. 1, a paper strip 1 is guided over two vertically spaced deflecting rolls 2 and 3. Between the two deflecting rolls 2 and 3 the strip 1 moves in the direction of arrow 5 in a straight path. Closely juxtaposed with the strip path is a rotatably mounted suction drum 5 that engages the paper strip in a line or narrow band. The interior of the suction drum 5 is connected to the intake of an unillustrated blower. The perforated surface of the suction drum 5 has relative to paper a higher coefficient of friction than paper does on paper. In order to achieve this, it is rubber coated. The suction drum 5 is connected with an unillustrated rotary drive. Closely juxtaposed below the suction drum is a blade 6. Its cutting edge, which is preferably serrated, is directed toward the suction drum, that is against the travel direction of the paper strip 1. The spacing between the paper strip 1 and the blade 6 determines the length of the residue of the flap; it thus is preferably at most a few millimeters.

In practice when the drive is shut off the suction drum 5 is moved into an unillustrated rest position out of contact with the paper strip 1. Shortly before a supply-roll change, the suction drum 5 is moved into the position of FIG. 1.

Simultaneously the blower is turned on. The drive is also turned on so that the suction drum 5 is rotated in the direction of arrow 7. The rotation rate is so high that its peripheral speed is substantially greater than the travel speed of the paper strip. The speeds lie at a ratio of between 1/1.5 and 1/10. Thus as soon as the glued location passes the contact line between the suction drum 5 and the paper strip 1, the flap 8, which to start with is pressed by the surrounding air flatly against the paper strip 1, is engaged frictionally by the suction drum 5. The outer surface of the suction drum 5 is in this case an envelope that is frictionally effective. The flap 8 is moved downstream with the peripheral velocity of the suction drum 5 so that its face turned toward the paper strip starts to slide. This bows out the downstream portion of the flap 8. The bowed-out flap 8 separated from the paper strip 1 engages the blade 6 and is thus cut off, leaving a harmless residue. Then the suction drum 5 is moved back into its rest position. This process is repeated each time a supply roll is changed, that is every 20 to 30 minutes.

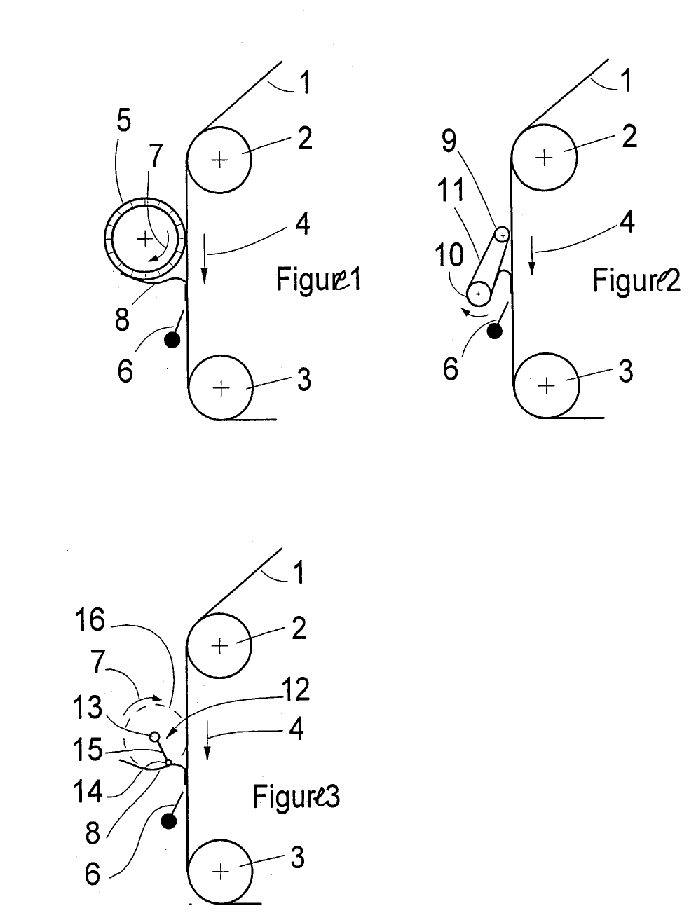

The apparatus shown in FIG. 2 is different from that described above in that instead of the suction drum 5 there is an endless suction belt 11 spanned over rolls 9 and 10. Between the active reach closer to the paper strip and the other reach there is a suction box that is open on its side toward the active reach. The suction box is connected with an unillustrated blower. When in use, the upper upstream roll 9 is so closely juxtaposed with the paper strip 1 that the suction belt 11 whose outer face is the envelope defined in claim 2 bears lightly on the paper strip 1. The spacing between the other roll 10 and the paper strip 1 is greater so that the spacing between the suction belt 11 and the paper strip 1 increases in the travel direction. Operation is like the operation describe with reference to FIG. 1 so that further discussion is unnecessary.

FIG. 3 shows a further embodiment wherein the entrainment element is a rotor 12 that is connected with an unillustrated rotary drive. The rotor 12 is formed mainly as a shaft 13 and a round rod 14 parallel to it and fixed to the shaft 13 by radial arms 15. The rod 14 is provided with a friction-increasing covering. The spacing between the axis of the shaft 13 when in use and the paper strip 1 is a little smaller than the radius of the envelope 16 which is defined by the orbit of the rotor 12. In other words, the rod 14 orbiting in the direction of the arrow 7 about the shaft 13 engages lightly on the passing paper strip 1.

It is clear that the rotor 12 can have a plurality of the rods 14 which are arranged like a star, angularly equispaced about the shaft 12.

In practice the flap 8 which moves past the rotor 12 is struck at least once by the rod 14. Preferably the lengths of the arms 15, the rotation rate of the rotor 12, and the number of rods 14 of the rotor 12 are such that each passing flap 8 is struck several times. With each blow the part of the flap 8 that is struck is frictionally engaged by the rod 14 that is moving faster than the paper strip 1 and is pushed relative to the paper strip 1 in the travel direction. Thus the leading part of the flap 8 is bowed out and separated from the paper strip. The flap 8 arrives at the blade 6 in this position and is cut off, leaving a harmless residue.

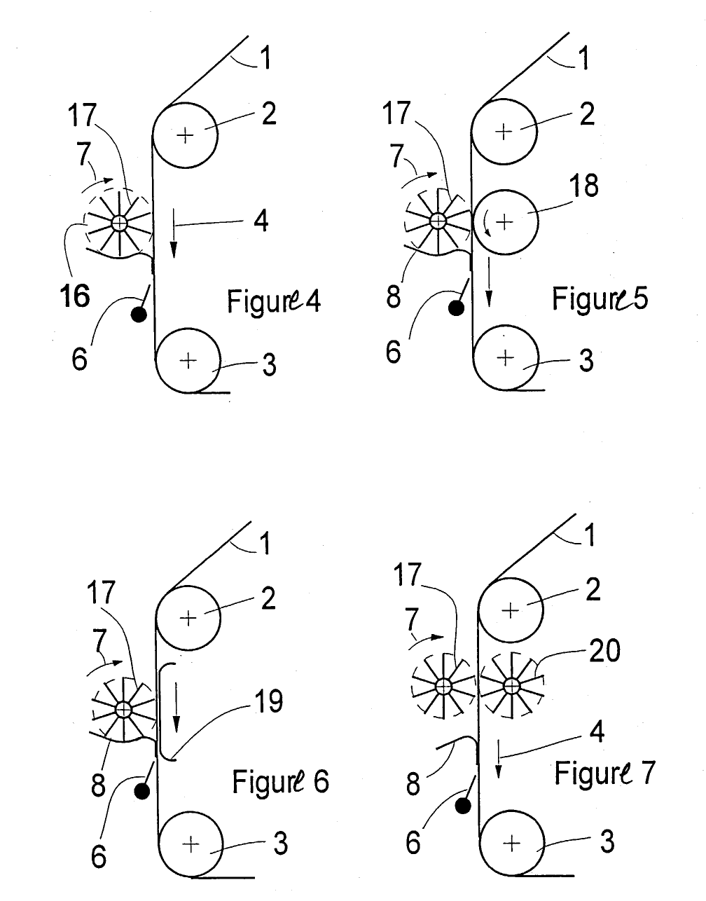

In the embodiment of FIG. 4 the separating element is a round brush 17 rotatable about its axis. The distance between the axis of the brush 17 and the paper strip 1 is a little smaller than the radius of the envelope 16. When the brush 17 is in its use position and rotates in the direction of the arrow 7, the paper strip 1 is stroked in a narrow band by the brush 17. When a flap 8 comes into the band-shaped effective range of the brush 17, it is moved by friction relative to the paper strip 1 in the travel direction so that the leading part of the flap 8, which has already passed the effective range, bows out.

In the embodiments shown in the remaining Figures, the separating element is a round brush 17. An inner side of the passing paper strip 1 engages opposite the brush 17 against a support, in FIG. 6 a support roll 8, in FIG. 6 a slide plate 19, and in FIG. 7 a round brush 20. The provision of a support element is particularly advantageous when the separating element is a round brush 17. The support bears with a countervailing force which is necessary to create sufficient friction. In the embodiment according to FIG. 7 the separating effect is increased by the repulsive effect of an electrical charge that is created by contact with the brushes 17 and 20 as well as with the flap 8 and paper strip 1.

1. A method of shortening a flap hanging off a continuously moving paper strip, in particular the flap left after an on-the-fly roll change downstream of a location where two paper strips are glued together,
wherein the paper strip is moved past a separating device moving faster than the paper strip and the flap is frictionally engaged by the separating device and separated from the paper strip and severed near the joined location,
characterized in that the flap is engaged by the separating device while it is still lying against the paper strip.

2. An apparatus for shortening a flap hanging off a continuously moving paper strip, in particular the flap left after an on-the-fly roll change downstream of a location where two paper strips are glued together, the apparatus comprising
guides for conducting the paper strip along a predetermined path and a driven and rotating separating device that is inside an envelope, that is driven faster than the paper strip, and that is able to exert a frictional force effective inside the envelope in the travel direction of the paper strip, characterized in that the envelope (16) is at least very closely juxtaposed with the paper strip (1).

3. The apparatus according to claim 2, characterized by a suction drum (5) as separating device.

4. The apparatus according to claim 2, characterized by a suction belt (11) as separating device.

5. The apparatus according to claim 2, characterized in that a rotor (12) serves as separating device and is comprised of a shaft (13) ant at least one rod (14) that is parallel to the shaft (13) and that is fixed at a radial spacing by arms (15) fixedly on the shaft (13).

6. The apparatus according to claim 2, characterized by a brush (17) as separating device.

7. The apparatus according to one of claims 2 to 6, in particular claim 6, characterized by a support (18, 19, 20) for the paper strip (1) and adjacent the separating device (5, 11, 12, 17).

8. The apparatus according to claim 2, characterized by a rotatably mounted roll (17) as separating device.

9. The apparatus according to claim 2, characterized by a fixed plate (19) as separating device.

10. The apparatus according to claim 2, characterized by a rotatable round brush (20) as separating device.
